(19) United States
(12) Patent Application Publication
(10) Pub. No.: US 2010/0192302 A1
(43) Pub. Date: Aug. 5, 2010

(54) Extremity support apparatus

(76) Inventors: Michael C. Di Lauro, Carlsbad, CA (US); Brian Brenner, Encinitas, CA (US)

Correspondence Address: G. L. LOOMIS & ASSOCIATES, INC., 990 HIGHLAND DRIVE, SUITE 212Q, SOLANA BEACH, CA, 92075, US

(21) Appl. No.: 12/699,719

(22) Filed: Feb. 3, 2010

Related U.S. Application Data
(63) Continuation-in-part of application No. 12/366,610, filed on Feb. 5, 2009.

(51) Int. Cl. A61G 1/04; A61G 7/075; A61G 5/12

(52) U.S. Cl. 5/621; 297/411.23

(57) ABSTRACT

The invention provides an adjustable apparatus, which is attachable to a medical emergency cot, gurney, wheeled stretcher, medical bed, medical chair or the like, and that functions to support and immobilize of an extremity of a human body. The apparatus has a cot attachment member to which is attached a movable linkage connected to an extension pole assembly which in turn is connected to an extremity support member and wherein certain combinations of relative movements of the movable linkage, the extension pole assembly and the extremity support member allow the apparatus to be disposed and secured in positions that support an extremity of a and wherein other combinations of relative movements allow the apparatus to be disposed in a storage position. In certain embodiments the apparatus is attachable to a chair for use in phlebotomy procedures.

### CROSS-REFERENCE TO RELATED APPLICATION

The present application is a continuation-in-part of co-owned U.S. application Ser. No. 12/366,610 filed on Feb. 5, 2009, which is hereby incorporated by reference in its entirety.

### FIELD OF THE INVENTION

The present invention relates generally to extremity supporting devices for use in combination with the patient transporters currently used in hospitals and ambulances, and specifically to an adjustable support device for maintaining an extremity of a patient in a supported position during transport or for procedures such as the administration of intravenous therapy.

### BACKGROUND OF THE INVENTION

Various types of ambulatory and medical emergency cots, gurneys, wheeled stretchers, medical beds, medical chairs and the like are utilized in patient transport and it is frequently necessary to administer medication or other fluids intravenously during transport by introducing a conduit into a body extremity of the patient. Most commonly the body extremity is an arm. In order to avoid injury and ensure proper administration, it is important that the patient's body extremity remain relatively immobile and straightened during the procedure. This is particularly important when the patient is transported in a moving vehicle, wherein the close quarters and abrupt movements can combine to produce a potentially hazardous environment. Additionally embodiments of the present invention can be used in combination with blood drawing stations such as phlebotomy chairs.

U.S. Pat. No. 3,528,413 to Aydt describes a splint for an injured arm that attaches to the rail of a bed or a field stretcher wherein the arm splint is attached to the rail via a c-clamp and provides only limited adjustability. Also, since the described arm splint encases the extremity, it does not permit transcutaneous access to the blood vessels of the extremity and therefore precludes procedures such as intravenous therapy.

U.S. Pat. No. 5,443,233 to Kabanek discloses an arm board for a gurney comprising a stiff flat board that not attached to the gurney, but that is rather slipped into crevice below the mattress and thus is held in place by the weight of the patient. Such an arm board configuration is limited in that it fails to provide any adjustability and requires that the arm of the patient be maintained in the same plane as the body.

U.S. Pat. No. 5,839,136 to Vance et al. describes an emergency cot mounted arm board that includes a cot frame attaching member, an arm board, and a pivot assembly coupling the attaching member and the arm board. However the arm board of this invention has limited adjustability since it is attached to the backrest and necessarily remains parallel to the horizontal plane of the cot. Also, the armboard of Vance is designed to support a patient's hand and lower arm and does not offer independent support to the upper arm. Furthermore, with such a configuration the arm board position changes if the position of the backrest is changed during transport of the patient.

U.S. Pat. No. 6,701,554 to Heimbrock discloses a transportable stretcher used in medical imaging with a pivotally coupled armboard. Since this stretcher is designed specifically for imaging procedures utilizing a C-arm apparatus, the pivotally coupled arm board provides only limited adjustability.

It is therefore an object of the present invention to provide a device, attachable to a medical emergency cot, gurney, wheeled stretcher, medical bed or medical chair to stabilize a body extremity a patient wherein the device can be easily positioned.

It is another object of the present invention to provide a device, attachable to a medical emergency cot, gurney, wheeled stretcher, medical bed or medical chair to stabilize a body extremity during transport of a patient wherein the device can be positioned to avoid unwanted pressure or tension on a limb.

It is another object of the present invention to provide a device, attachable to a medical emergency cot, gurney, wheeled stretcher, medical bed or medical chair to stabilize a body extremity during transport of a patient wherein the device is rigid in design to minimize vibration during patient transport.

It is another object of the present invention to provide a device, attachable to a medical emergency cot, gurney, wheeled stretcher, medical bed or medical chair to support a body extremity during transport of a patient in a manner that permits transcutaneous access to the blood vessels of the extremity and therefore allows performance of procedures such as intravenous therapy.

It is another object of the present invention to provide a device, attachable to a medical emergency cot, gurney, wheeled stretcher, medical bed or medical chair to stabilize a body extremity during transport of a patient wherein the device can be conveniently adjusted to fit the full range patient sizes.

It is another object of the present invention to provide a device, attachable to a medical emergency cot, gurney, wheeled stretcher, medical bed or medical chair to stabilize a body extremity during transport of a patient that provides for convenient and effective immobilization of a patient's extremity if the position of the backrest is changed during transport.

It is another object of the present invention to provide a device, attachable to a medical emergency cot, gurney, wheeled stretcher, medical bed or medical chair to stabilize a body extremity during transport of a patient wherein the device can be positioned to not exceed the boundary planes defined by the emergency cot when not in use.

It is another object of the present invention to provide a device, attachable to a medical emergency cot, gurney, wheeled stretcher, medical bed or medical chair that can be used in combination with to a phlebotomy chair so that the present invention stabilizes and holds the extremity in the extended position to safely and effectively draw blood.

These and other objects of the present invention will be apparent from a review of the following specification and accompanying drawings.

### BRIEF DESCRIPTION OF THE DRAWINGS

FIG. 1 is a partially exploded isometric view of an extremity support apparatus disposed in an extended position attached to a medical cot.

FIG. 2 is an assembled isometric view of the extremity support apparatus of FIG. 1 disposed in an extended position attached to a medical cot.

FIG. 3 is an isometric view of the extremity support apparatus of FIG. 2. disposed in a storage position attached to a medical cot.

FIG. 4 is an orthogonal side view of a medical cot with an extremity support apparatus disposed in an extended position.

FIG. 5 is a detailed view of the extremity support apparatus of FIG. 4.

FIG. 6 is an orthogonal end view of a medical cot with an extremity support apparatus disposed in an extended position.

FIG. 7 is an orthogonal rear view of an extension assembly and an extremity support member of a support apparatus in an extended position.

FIG. 8 is an orthogonal side view of an extension assembly and an extremity support member of a support apparatus in an extended position.

FIG. 9 is a front orthogonal rear view of an extension assembly and an extremity support member of a support apparatus in an extended position.

FIG. 10 is an isometric frontal view of an extremity support apparatus in a partially extended position depicting a rod/perforated plate locking mechanism.

FIG. 10A is an isometric rear view of an extremity support apparatus in a partially extended position depicting a rod/perforated plate locking mechanism.

FIG. 11 is an isometric frontal view of an extremity support apparatus in a storage position depicting a locking rod and rod/perforated plate locking mechanism.

FIG. 11A is an isometric rear view of an extremity support apparatus in a storage position depicting a locking rod and rod/perforated plate locking mechanism.

FIG. 12 is an isometric view of an embodiment of a four-bar linkage of an extremity support apparatus disposed in a partially extended position while attached to a rail of a medical cot.

FIG. 13 is an isometric view of an embodiment of a four-bar linkage of an extremity support apparatus disposed in a partially extended position while attached to a rail of a medical cot.

FIG. 14 is an isometric view of an embodiment of a moveable linkage, in the form of a hinged coupling, of an extremity support apparatus disposed in a partially extended position while attached to a rail of a medical cot.

FIG. 15 is an isometric view of an embodiment of a moveable linkage, in the form of a hinged coupling, of an extremity support apparatus disposed in a partially extended position while attached to a rail of a medical cot.

FIG. 16 is an isometric view of an embodiment of an extremity apparatus attached to an arm of a chair for use in phlebotomy procedures.

FIG. 17A is an isometric view of an extremity support apparatus attached to a frame rail of an emergency cot, wherein the apparatus is disposed in a closed or storage position.

FIG. 17B is a perspective view of the extremity support apparatus attached to a frame rail of an emergency cot as presented in FIG. 17A, wherein the apparatus is disposed an extended position.

FIG. 18 is a top orthogonal view of the extremity support apparatus of FIGS. 17A and 17B.

FIG. 19A is an orthogonal side view of an embodiment of an extension pole assembly with an attached extremity support member.

FIG. 19B is an orthogonal frontal view of an embodiment of an extension pole assembly with an attached extremity support member.

FIG. 19C is a partial sectional orthogonal side view of an embodiment of an extension pole assembly with an attached extremity support member.

### SUMMARY OF THE INVENTION

The present invention provides an adjustable device, which is removedly attachable to a medical emergency cot, gurney, wheeled stretcher or the like, that functions to support and immobilize an extremity of a human body, i.e. limb, during transport or during performance a medical procedure. The device is of simple construction and yet rigid and easily adjustable in five modes from three or four quickly accessible adjustment points. The apparatus can support the limb in a stationary position and can be tilted from two horizontal pivot points and rotated around a vertical axis. A preferred configuration comprises a main support section or member comprising two ends, wherein the first end is pivotally mounted to a clamp which is fastened to the rail of a medical emergency bed or cot; an end-support means pivotally mounted on the main member at the second end; and an adjustable limb retaining means rotatably mounted on the end-support. Such an apparatus is of simple construction and yet permits a high degree of adjustability.

A typical embodiment of such an apparatus attachable to an emergency cot has one or more cot attachment members attachable to a rail component of the cot to which is attached a movable linkage; rotatably coupled to the movable linkage is an extension pole assembly comprising an outer tube and an inner tube telescopically coupled within the outer tube to which an extremity support member is rotatably coupled; wherein certain combinations of relative movements of the movable linkage, the extension pole assembly and the extremity support member allow the apparatus to be disposed and secured in positions that support an extremity of a patient lying on the emergency cot and wherein other combinations of relative movements of the movable linkage, the extension pole assembly and the extremity support member allow the apparatus to be disposed and secured in a storage position. A preferable storage position is beneath the surface of the cot. Certain embodiments of apparatuses of the present invention are particularly suitable for use in combination with to a phlebotomy chair so that the present invention stabilizes and holds the extremity in the extended position to safely and effectively draw blood.

In certain embodiments the moveable linkage is a four-bar linkage, a three-bar linkage, a hinged coupling or a ball-joint linkage. In certain preferred embodiments of the extremity support apparatus, a rail of the cot to which the apparatus is attached defines one bar of the four-bar linkage. In certain embodiments the four bar linkage further comprises a locking mechanism comprising a locking rod and perforated flat plate mechanism.

In certain embodiments of the extremity support apparatus of the present invention at the extension pole assembly and/or the support member is provided with a locking means including but not limited to a friction clamp having a lead screw, a quick release clamp having a non-circular cam and a friction collar or collet.

In certain preferred embodiments the apparatus has a diagonal brace member with a body having a proximal end, a distal end and a slot extending through the body along its longitudinal axis from a point near the distal end and extending to a point at least past the center point of the longitudinal axis, wherein the proximal end of the diagonal brace is pivotally attached to the movable linkage and wherein the extension pole assembly comprises a locking pin slidably coupled through the slot of the diagonal support such that the diagonal brace member functions to impart rigidity and strength the apparatus as the extension pole assembly is pivotally rotated relative to the movable linkage.

Certain embodiments of the apparatus of the present invention provide a stabilization mechanism comprising a rod disposed along and parallel to the longitudinal axis of the outer tube of the extension pole assembly wherein the rod is attached to the outer tube near the proximal end and distal end of the outer tube such that a space is maintained between the rod and the outer tube; and a plate comprising a slot having an open end and a closed end; wherein the plate is attached to said one or more cot attachment members such that the slot is parallel to the rail component to which the one or more cot attachment members are attachable such that the slot engages the rod when the apparatus is in an extended position for use in supporting an extremity of a patient. In certain embodiments of such a stabilization mechanism is to provide a locking mechanism having a slotted lever rotatably attached to the slotted plate and a slotted plate pin fixedly attached to the slotted plate at or near the open end of the slotted plate slot wherein the slotted lever comprises a lever slot sized and positioned to engage the slotted plate pin and functioning to prevent the outer tube rod from disengaging when disposed in the slotted plate slot.

In certain other preferred embodiments the cot attachment member comprises one or more C-clamps. In certain other preferred embodiments the extremity support member is contoured to conform to the general shape of a patient's extremity and in yet other embodiments the extremity support member further comprises a replaceable pad.

In certain preferred embodiments, the extremity support member is both contoured to conform to a general shape of a patient's upper extremity, including the patients arm and hand, to afford the healthcare provider access to either the patient's arm or hand.

In certain other embodiments of the apparatus of the present invention the cot attachment member is fixedly attachable to a frame component of a cot by a means such as welding to afford a unitary construction.

The present invention also provides a method of affording extremity support for a patient being transported in an emergency cot comprising the steps of: i. providing an extremity support apparatus of the present invention; ii. attaching the apparatus to an emergency cot; iii. adjusting and securing the apparatus in a position appropriate for supporting a patient's extremity; and iii. disposing the patient's extremity within the support member.

Other embodiments of the present invention provide an adjustable apparatus that is attachable to an arm of a chair for use in phlebotomy procedures. In such embodiments the apparatus is attachable to an arm of a suitable chair and certain combinations of relative movements of the movable linkage, the extension pole assembly and the extremity support member allow the apparatus to be disposed and secured in positions that support an arm of a patient sitting in the chair for a phlebotomy procedure. A method of affording arm support for a patient seated in a chair for a phlebotomy procedure comprises the steps of: i. providing a suitable arm support apparatus of the present invention; ii. attaching the apparatus to the arm of the a suitable chair; iii. adjusting and securing the apparatus in a position appropriate for supporting a patient's arm; and iii. disposing the patient's extremity within the support member.

### DETAILED DESCRIPTION OF THE INVENTION

For purposes of the present invention the terms medical emergency cot, gurney, transport stretcher, ambulance stretcher, wheeled stretcher, medical bed, medical chair and patient transfer stretcher are synonymous.

For purposes of the present invention a four-bar linkage also referred to as a 4-bar or four-bar is the well known movable linkage consisting of four rigid bodies, often called bars or links, each attached to two others by single joint or pivots to form a closed loop.

For purposes of the present invention a three-bar linkage also referred to as a 3-bar or three-bar is a well-known movable linkage consisting of three rigid bodies, a three-bar linkage is often employed in place of a conventional four-bar linkage

Embodiments of the present invention provide an adjustable apparatus, which is attachable to a medical emergency cot, gurney, wheeled stretcher or the like to support and immobilize an extremity of a human body, i.e. limb, during medical procedures such as the administration of intravenous therapy. In general such an apparatus has a cot attachment member attachable to a cot; a movable linkage fixedly attached to the cot attachment member; an extension pole assembly comprising an outer tube with a proximal end and a distal end, wherein the outer tube proximal end is pivotably attached to the movable linkage, and an inner tube with a proximal end and a distal end wherein the inner tube proximal end is telescopically coupled within the outer tube; and an extremity support member rotatably coupled to the distal end of the inner tube of the extension pole assembly, wherein certain combinations of relative movements of the movable linkage, the extension pole assembly and the extremity support member allow the apparatus to be disposed and secured in positions that support an extremity of a patient lying on the emergency cot and wherein other combinations of relative movements of the movable linkage, the extension pole assembly and the extremity support member allow the apparatus to be disposed and secured in a storage position beneath the surface of the cot.

Suitable cot attachment members can be in the form of one or more of a variety of C-clamps; G-clamps; band clamps, such as T-bolt band clamps or worm gear band clamps; straps or the like.

The moveable linkage can be a three-bar linkage, a four-bar linkage, a slidable linkage, a hinged coupling, a ball-joint linkage or any similar coupling that permits the overall positioning of the apparatus in a function extremity support position as well as a storage position.

In certain embodiments the cot attachment member is fixedly attachable to the cot and in certain other embodiments the cot attachment member is removedly attachable to the cot. In certain preferred embodiments the cot attachment member is attachable to a side rail or frame rail of the cot.

In certain preferred embodiments the moveable linkage is a four-bar linkage is attached to the cot attachment member such that movements of the four-bar linkage are in the plane of the cot surface. The telescopic coupling of the outer tube and an inner tube of the extension pole assembly which renders these tubes slidably and rotatably movable with respect to one another, while the extremity support member is rotatably coupled to the distal end of the inner tube of the extension assembly. Such a configuration of components permits a combination of movements or adjustments of the components to deploy and secure the apparatus in the optimum position to function as an effective support for an extremity of a patient, while other combinations of movements or adjustments permits the apparatus to be secured in a protected storage position beneath the surface of the cot.

In certain embodiments the extremity support member has a brace that is contoured to conform to the shape of the patient's extremity to be supported, including the patient's hand and arm.

In certain preferred embodiments the apparatus is further provided with a slotted diagonal brace member one end of which is pivotally attached to an edge of the four-bar linkage by means of a locking pin or other suitable coupling means and the extension assembly has a locking pin that extends through the slot in the brace member thereby slidably coupling the diagonal brace to the extension assembly such that the diagonal brace member functions to impart and maintain rigidity and strength to the apparatus as the extension assembly in all extremity support positions of the extension assembly.

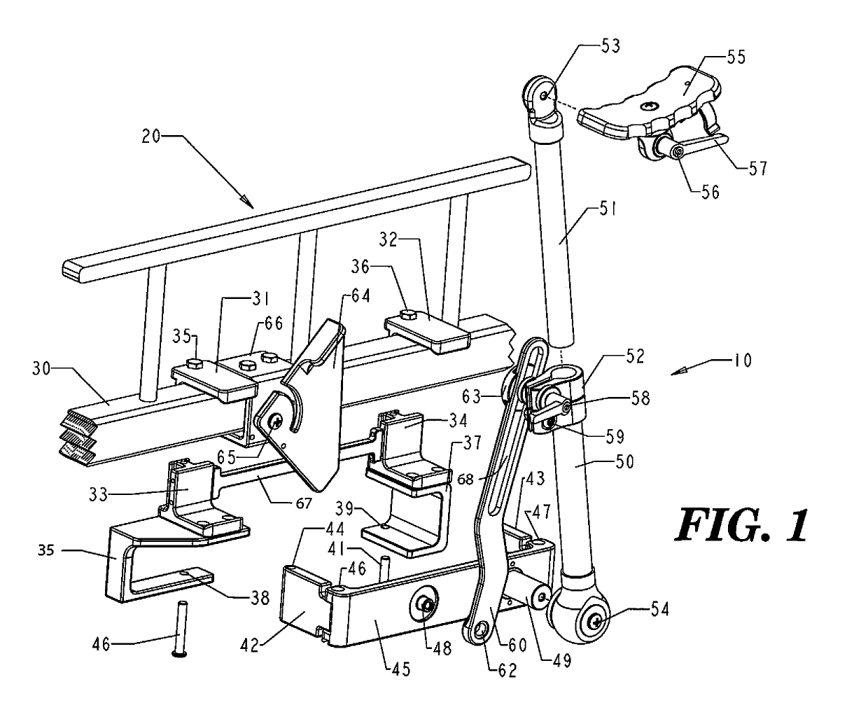

In FIG. 1 is illustrated a partially exploded isometric view of a typical embodiment of an extremity support apparatus 10 of that clearly shows the relationship of the individual components. Two cot attachment members each in the form of a C-clamp consist of upper C-clamp elements 31 and 32 slidably coupled to lower C-clamp elements 33 and 34 respectively wherein each cot attachment member is provided with a screw 35 and 36 that couples with a threaded hole in the lower C-clamp elements and functions as a locking means to secure the cot attachment members to frame rail 30 of hospital cot side rail 20. Such an arrangement permits facile attachment or removal of the extremity support apparatus to or from the cot. Also in the embodiment illustrated in FIG. 1 an optional spacer bar 67 is coupled to lower C-clamp elements 33 and 34 and functions to hold the position of elements 33 and 34 such that the rotation of side elements 42 and 43 remains parallel. Such an optional spacer functions as an aid to the attachment of the two cot attachment members to a cot and further functions to add rigidity to the apparatus. Attached to lower C-clamp elements 33 and 34 respectively are four-bar linkage rear elements 35 and 37, which in turn are hingedly attached to four-bar linkage side elements 42 and 43 while a four-bar linkage front element 45 is hingedly attached to four-bar linkage side elements 42 and 43. In some embodiments of the four-bar linkage as depicted in FIG. 1, which do not employ the optional spacer bar 67, it is the frame rail 30 that in essence functions as a one bar of the four-bar linkage.

Further depicted in FIG. 1 is an extension assembly with an inner tube 51 telescopically and rotatably coupled within an outer tube 50 and an extremity support member 55 rotatably coupled to the extension assembly by means of a locking pin or clamping handle 56 that passes through a hole 53 in the distal end of the inner tube 51. In this depicted embodiment the extremity support member 55 has a top surface that is contoured to conform to the shape of a patients' extremity, with added grooves to contour to the patient's hand and has an extremity support component locking means 57 in the form of a lever actuated friction clutch mechanism or a compressive force exerted by a lead screw. Also, in the embodiment depicted in FIG. 1 the apparatus 10 is further provided with a slotted diagonal brace member 60 having a diagonal brace attachment element 62 at the proximal end that is pivotably attached to a mating attachment element 48 on the front plate 45 of the four-bar linkage and wherein the extension assembly outer tube 50 is slidably coupled to the diagonal brace member 60 by brace member locking means 58 extending through a collar 52 and through the slot 68, wherein the diagonal brace member 60 is retained by the retention disc 63. The diagonal brace member 60 functions to impart and maintain overall rigidity and strength to the extremity support apparatus when the apparatus 10 is disposed in an extended functional position. The diagonal brace member locking means 58 can be any suitable locking mechanism including, but not limited to, a lever actuated friction clutch mechanism, a locking pin, a clamping handle or the like. It should be noted that in this embodiment the brace member locking means 58 that is used to maintain the diagonal brace member 60 in a desired position also functions to secure the collar 52 to the outer tube 50. Also depicted as an optional component is a retaining plate 64, which is pivotably attached to a retaining plate C-clamp 66 by means of a bolt 65.

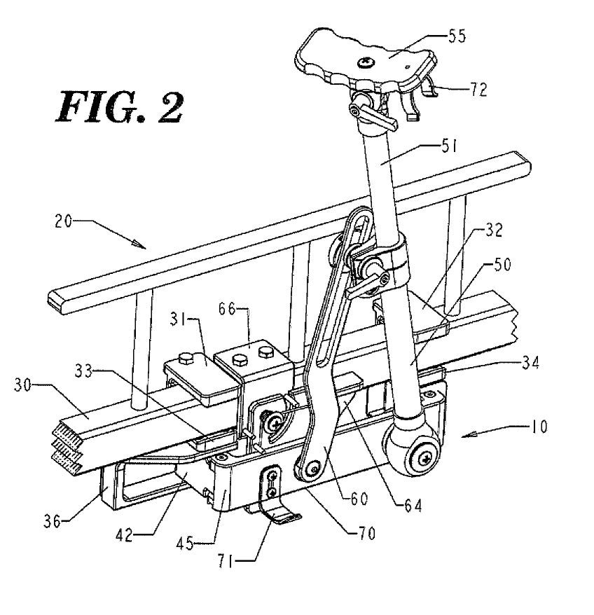

In FIG. 2 is presented an isometric view of the extremity support apparatus 10 depicted FIG. 1 wherein the components are fully assembled and is disposed in an extended functional position. In FIG. 2 to the four-bar linkage front element 45 further comprises a cradle in the form of a hook 71 which functions to accommodate and aid in securing the extension assembly when the apparatus is in the storage position.

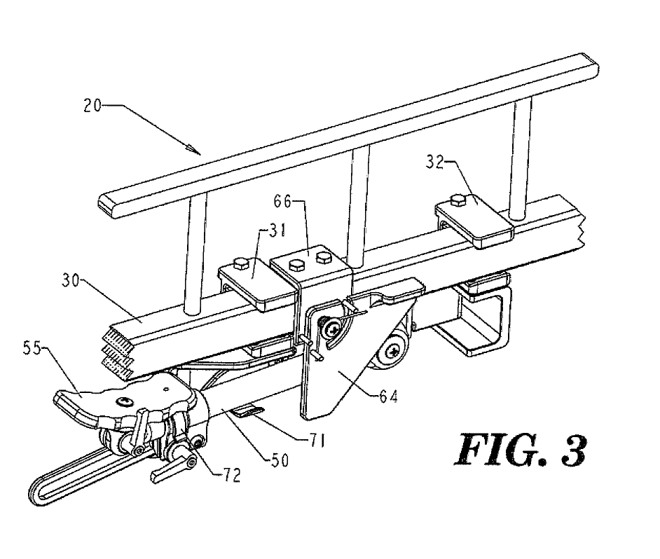

In FIG. 3 is presented an isometric view of the extremity support apparatus 10 wherein the components are fully assembled and wherein the apparatus 10 is disposed in a storage position under the frame rail 30 of hospital cot side rail 20. Also as illustrated in FIG. 3 the retaining plate 64 is rotated into a position wherein the top edge is parallel to the frame rail 30 wherein the retaining plate 64 functions to aid in the retention of apparatus 10 is in the storage position.

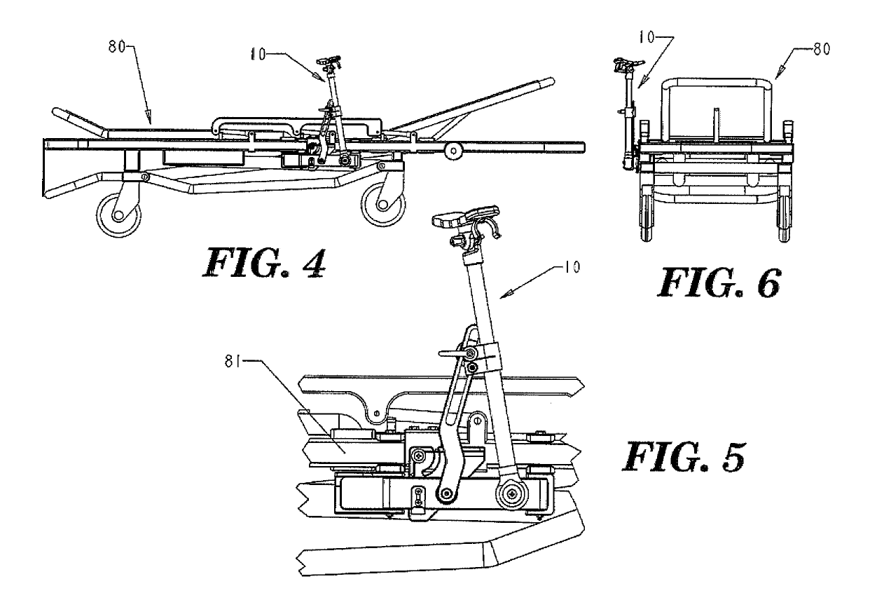

Depicted in FIG. 4 is an orthogonal side view of a medical cot 80 to which is affixed an extremity support apparatus 10, wherein the apparatus 10 is disposed in an extended functional position. FIG. 5 is a detailed view of the extremity support apparatus 10 of FIG. 4 showing the attachments to a frame rail 81. Depicted in FIG. 6 is an orthogonal end view of medical cot 80 with extremity support apparatus 10 disposed in an extended functional position.

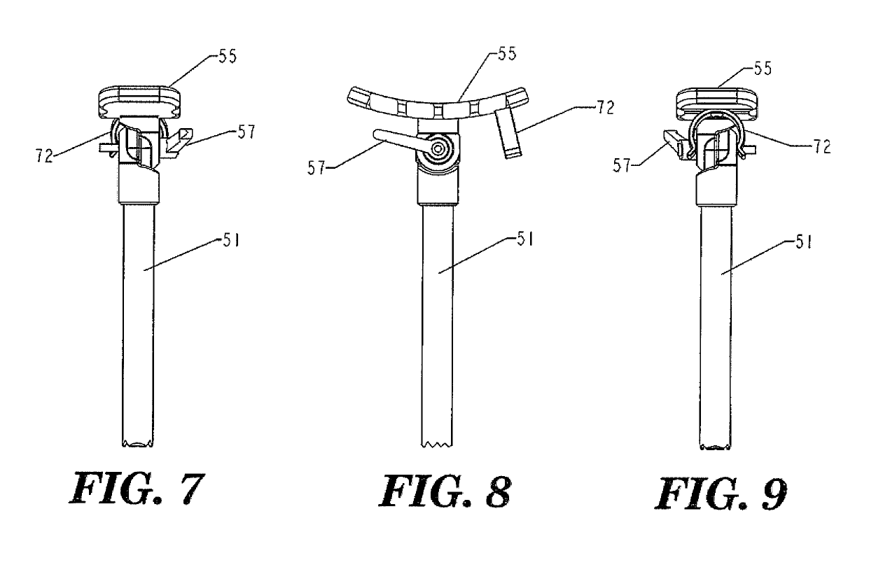

Illustrated in FIG. 7 is an orthogonal rear view of an extension assembly inner tube 51 rotatably coupled to extremity support member 55 disposed in a functional position. FIG. 8 presents an orthogonal side view of the extension assembly inner tube 51 rotatably coupled to extremity support member 55 disposed in a functional position and FIG. 9 presents a frontal orthogonal rear view of the extension assembly inner tube 51 rotatably coupled to extremity support member 55 disposed in a functional position. The locking mechanism 57 depicted in FIGS. 7, 8 and 9 allows for retention in a desired position of the extremity support member 55 relative to extension assembly inner tube 51. Also depicted is an open spring clamp 72 sized to accommodate and retain the extension assembly inner tube 51 when the apparatus is in a storage position.

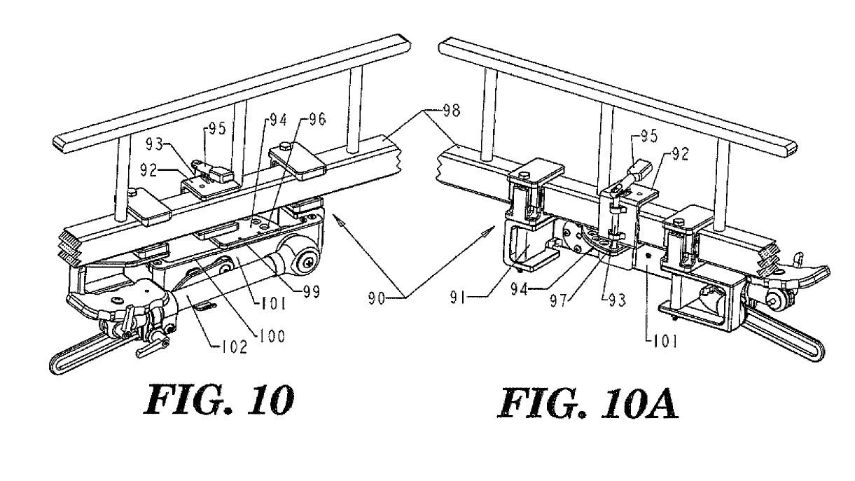

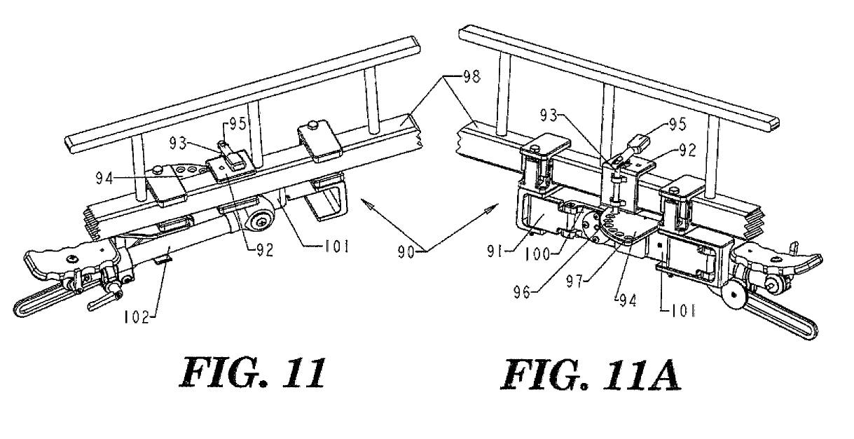

Illustrated in FIGS. 10, 10A, 11 and 11A is an embodiment of an extremity support apparatus of the present invention that includes a locking mechanism incorporating a locking rod 93 and perforated flat plate 94 to retain a four-bar linkage 90 and the extension assembly 102 attached thereto in either an extended position or a storage position. In FIG. 10 is depicted is an isometric frontal view of an apparatus attached to a cot frame rail 98 wherein the four-bar linkage 90 is in an extended position, while in FIG. 10A is depicted is an isometric rear view of an apparatus attached to a cot frame rail 98 wherein the four-bar linkage 90 is in an extended position. In FIG. 11 is depicted is an isometric frontal view of an apparatus attached to a cot frame rail 98 wherein the four-bar linkage 90 is in a storage position, while in FIG. 11A is depicted is an isometric rear view of an apparatus attached to a cot frame rail 98 wherein the four-bar linkage 90 is in a storage position. The perforated flat plate 94 has a front edge 99 fixedly attached to a top edge 100 of the frontal four-bar linkage element 101. In such a configuration the perforated flat plate 94 to is perpendicular to the frontal four-bar linkage element 101 and moves under the cot frame rail 98 as the four-bar linkage 90 is extended and retracted. A locking rod 93 is slidably attached to a locking rod retaining C-clamp 92 such that the locking rod 93 is always perpendicular to the plane of the perforated flat plate 94 and wherein the locking rod 93 is dimensioned to fit through the perforations in the perforated flat plate 94 that extend around the perimeter from the frontal perforation 96 to the rear perforation 97 (see FIG. 10A). To engage the desired perforation the locking rod 93 is raised and lowered as necessary by the action of the locking rod lever 95, which is hingedly attached to the topmost extremity of the locking rod 93. In FIGS. 10 and 10A the locking rod 93 is engaged in the rear perforation 97 thereby locking and retaining the four-bar linkage 90 in an extended position. In FIGS. 11 and 11A the locking rod 93 is engaged in the frontal perforation 96 thereby locking and retaining the four-bar linkage 90 in a storage position beneath the cot frame rail 98. In certain embodiments the locking rod lever 95 is provided with a spring mechanism that holds the locking rod 93 in a lowered position, such that it can engage and extend through a perforation in the perforated flat plate 94 and wherein depressing the locking rod lever 95 raises the locking rod 93 to disengage it from a perforation and allows the perforated flat plate 94 to move when the four-bar linkage 90 is extended.

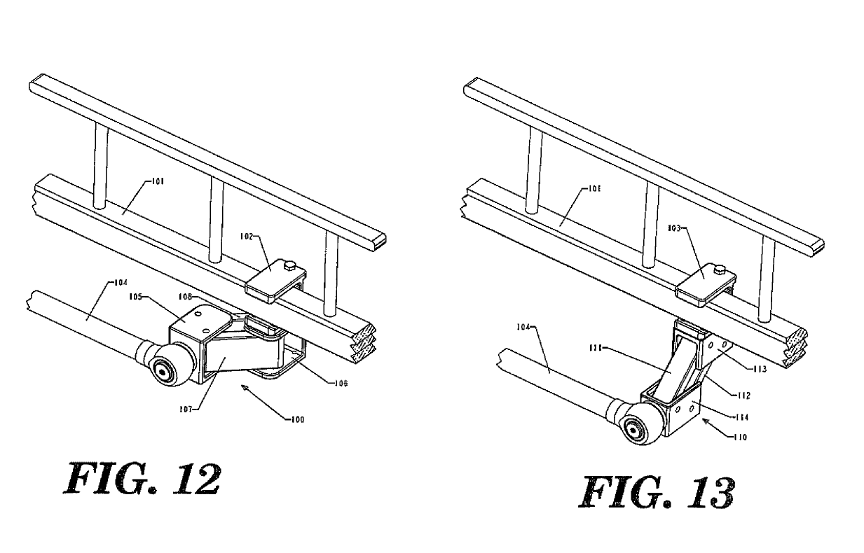

In FIG. 12 is illustrated an isometric view of an embodiment of a four-bar linkage of an extremity support apparatus of the present invention. The four-bar linkage 100 is attached to a medical cot frame rail 101 by a C-clamp 102 and is disposed in a partially extended position. The four-bar linkage 100 comprises: a first four-bar linkage end component 105 rotatably attached to extension assembly 104; a second four-bar linkage end component 106 fixedly attached to the C-clamp 102; a first four-bar linkage plate 107 having a first end disposed within and hingedly attached to the first four-bar linkage end component 105 and a second end disposed within and hingedly attached to the second four-bar linkage end component 106; and a second four-bar linkage plate 108 having a first end disposed within and hingedly attached to the first four-bar linkage end component 105 and a second end disposed within and hingedly attached to the second four-bar linkage end component 106. Such a configuration permits movement the extremity support apparatus of which four-bar linkage 100 is a component to move freely in a plane parallel to the pane of the cot to which it is attached.

In FIG. 13 is illustrated an isometric view of another embodiment of a four-bar linkage of an extremity support apparatus of the present invention. The four-bar linkage 110 is attached to a medical cot frame rail 101 by a C-clamp 103 and is disposed in a partially extended position. The four-bar linkage 110 comprises: a first four-bar linkage end component 114 rotatably attached to extension assembly 104; a second four-bar linkage end component 113 fixedly attached to the C-clamp 103; a first four-bar linkage plate 111 having a first end disposed within and hingedly attached to the first four-bar linkage end component 114 and a second end disposed within and hingedly attached to the second four-bar linkage end component 113; and a second four-bar linkage plate 112 having a first end disposed within and hingedly attached to the first four-bar linkage end component 114 and a second end disposed within and hingedly attached to the second four-bar linkage end component 113. Such a configuration permits movement the extremity support apparatus of which four-bar linkage 110 is a component to move freely in a plane perpendicular to the plane of the medical cot to which it is attached.

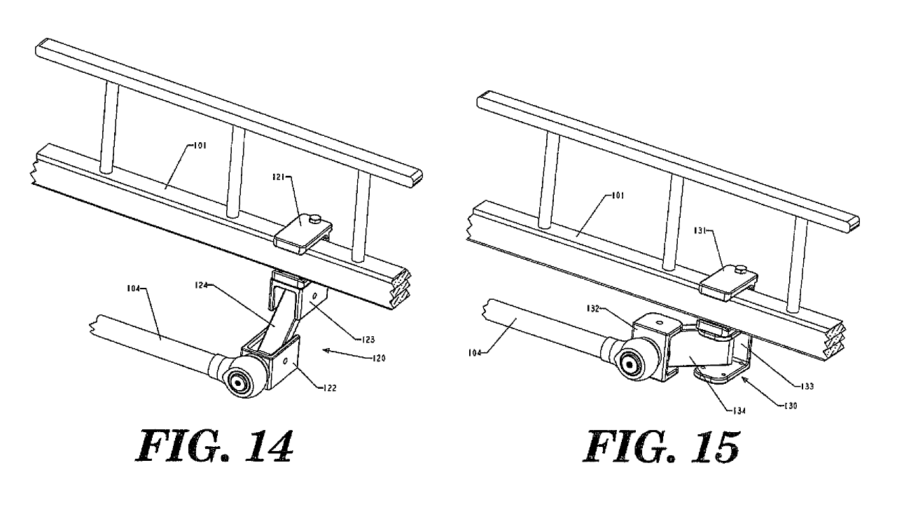

In FIG. 14 is illustrated an isometric view of an embodiment of a moveable linkage, in the form of a hinged coupling 120 of an extremity support apparatus of the present invention. The hinged coupling 120 is attached to a medical cot frame rail 101 by a C-clamp 121 and is disposed in a partially extended position. The hinged coupling 120 comprises: a first hinged coupling end component 122 rotatably attached to extension assembly 104; a second hinged coupling end component 123 fixedly attached to the C-clamp 121; and a hinged coupling plate 124 having a first end disposed within and hingedly attached to the first hinged coupling end component 122 and a second end disposed within and hingedly attached to second hinged coupling end component 123. Such a configuration permits movement the extremity support apparatus of which the hinged coupling 120 is a component to move freely in a plane perpendicular to the plane to the plane of the medical cot to which it is attached.

In FIG. 15 is illustrated an isometric view of an embodiment of a moveable linkage, in the form of a hinged coupling 130 of an extremity support apparatus of the present invention. The hinged coupling 130 is attached to a medical cot frame rail 101 by a C-clamp 131 and is disposed in a partially extended position. The hinged coupling 130 comprises: a first hinged coupling end component 132 rotatably attached to extension assembly 104; a second hinged coupling end component 133 fixedly attached to the C-clamp 131; and a hinged coupling plate 134 having a first end disposed within and hingedly attached to the first hinged coupling end component 132 and a second end disposed within and hingedly attached to second hinged coupling end component 133. Such a configuration permits movement the extremity support apparatus of which the hinged coupling 130 is a component to move freely in a plane parallel to the plane of the medical cot to which it is attached.

Certain embodiments of the present invention provide an adjustable apparatus, which is attachable to an arm rail of a chair useful in phlebotomy procedures. Such embodiments comprise: a chair attachment member attachable to an arm of the chair; a movable linkage attached to the chair attachment member; an extension pole assembly comprising an outer tube with a proximal end and a distal end, wherein the outer tube proximal end is pivotably attached to the movable linkage, and an inner tube with a proximal end and a distal end wherein the inner tube is telescopically coupled within the outer tube; and an extremity support member rotatably coupled to the distal end of the inner tube of the extension pole assembly; wherein certain combinations of relative movements of the movable linkage, the extension pole assembly and the extremity support member allow the apparatus to be disposed and secured in positions that support an arm of a patient sitting in the chair for a phlebotomy procedure. The moveable linkages, attachment members, extension pole assemblies and extremity support members herein described for the cot-attachable embodiments are also suitable for the chair-attachable embodiments.

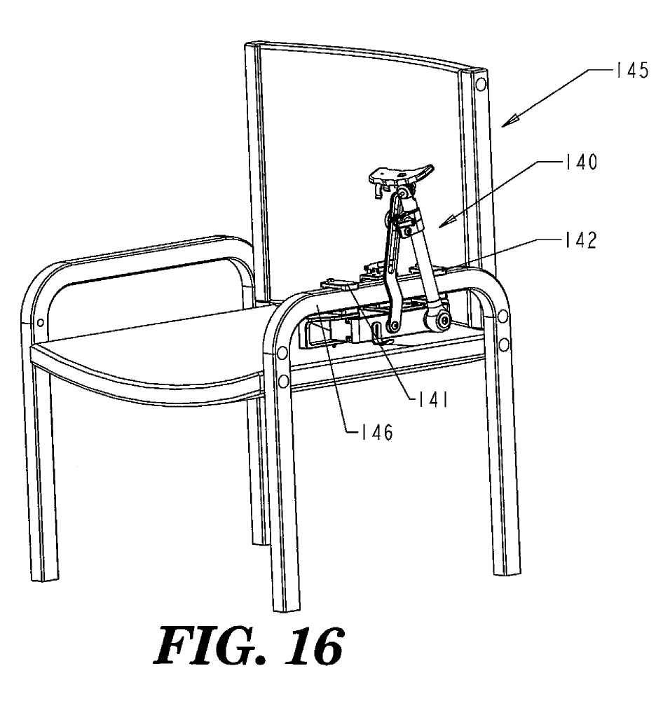

Depicted in FIG. 16 is an isometric view of an extremity support apparatus 140 affixed to a chair arm rail 146 of chair 145, wherein the apparatus 140 is suitably disposed in an extended functional position to accept the forearm of a patient seated in chair 145 for a phlebotomy procedure. In this embodiment, illustrated as extremity support apparatus 140, the chair attachment member comprises C-clamps 141 and 142, which are attached to chair arm 146.

Certain embodiments of the extremity support apparatus of the present invention provide a novel mechanism for stabilization of the apparatus when disposed in an extended functional. Typically the stabilization mechanism comprises an outer tube rod disposed along the longitudinal axis of the outer tube of an extension pole assembly and a slotted plate attached to the top surface of the attachment members that function to affix the apparatus to a rail of an emergency cot or arm of a phlebotomy chair. In use the extension pole assembly outer tube rod is disposed in the slot of the slotted plate, which helps to retain the extension pole assembly in a desired position. Certain embodiments also employ an optional lever actuated cam-type locking mechanism that functions to prevent the outer tube rod disposed in the slot from disengaging from the slot.

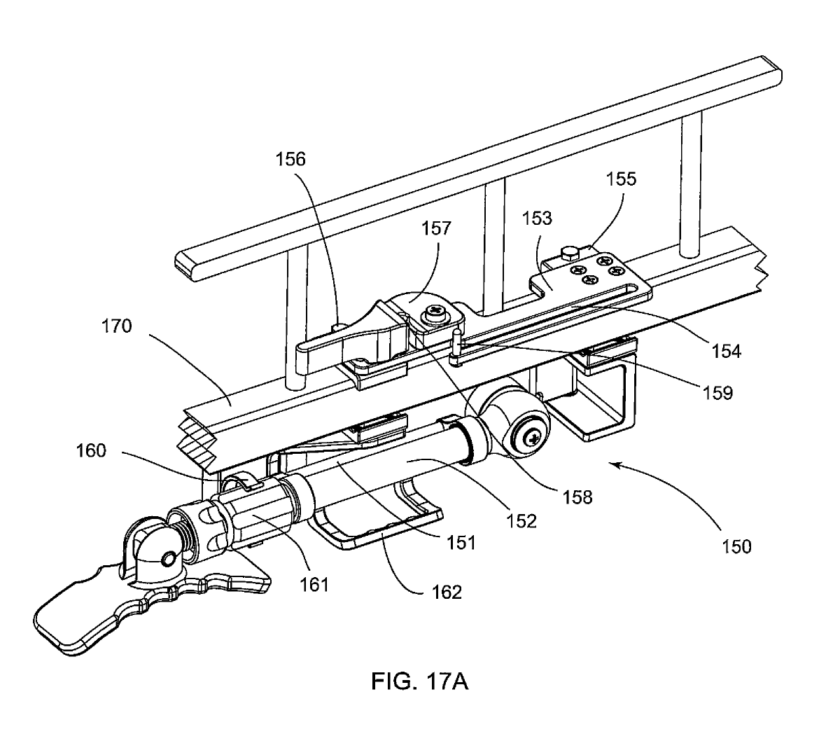

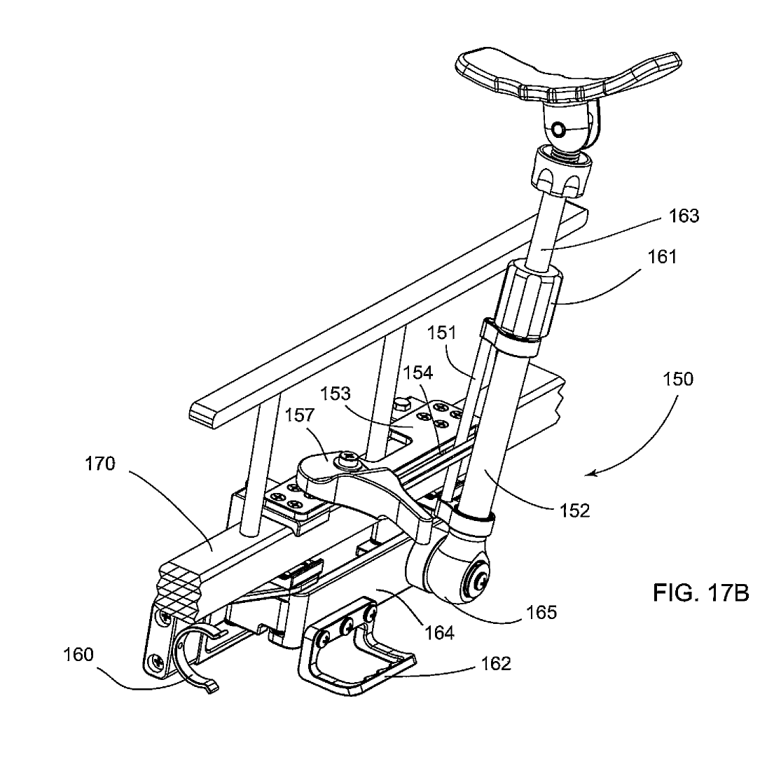

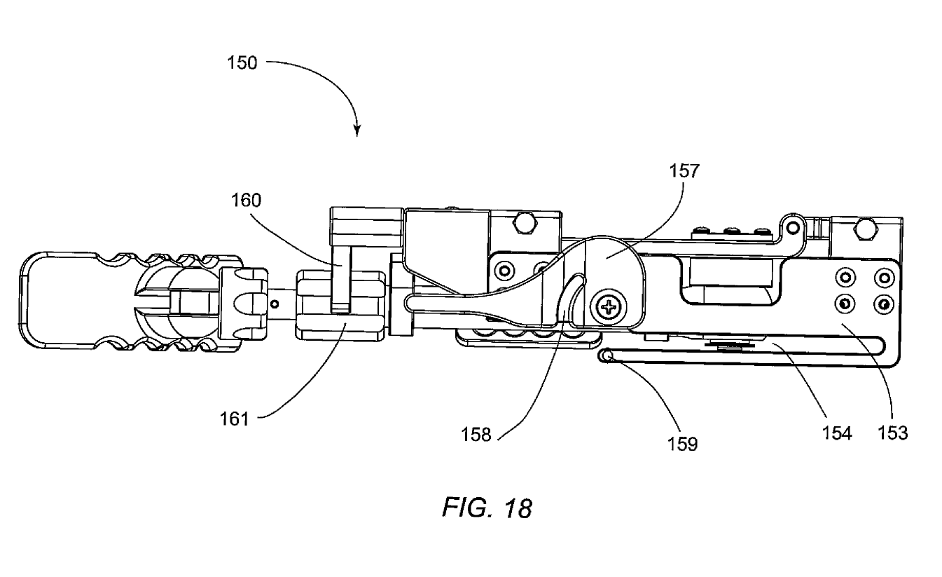

In FIG. 17A is illustrated an embodiment of an extremity support apparatus 150 with a stabilization mechanism as described above wherein the apparatus 150 is attached to a frame rail 170 of an emergency cot and is disposed in a closed or storage position. The stabilization mechanism comprises an extension pole rod 151 disposed along the longitudinal axis of the outer tube 152 of an extension pole assembly and a slotted plate 153 having a geometry that defines a slotted plate slot 154 having an open end and a closed end disposed to be parallel to the longitudinal axis of the frame rail 170, wherein the slotted plate 153 is attached to the top surface of rail attachment members 155 and 156 such that the slotted plate slot 154 is positioned to engage the extension pole rod 151 when the apparatus is in an extended position for use in supporting an extremity of a patient. Extremity support apparatus 150 has an optional lever actuated cam-type locking mechanism 157 that functions to prevent the extension pole rod extension pole rod 151 from disengaging when disposed in the slotted plate slot 154. The locking mechanism 157 comprises a locking mechanism slot 158 that is sized and positioned to engage a slotted plate pin 159 disposed at or near the open end of slotted plate slot 154. The extremity support apparatus 150 is also provided with an optional extension pole assembly retaining-clip 160 that functions to secure the extension pole assembly by springedly engaging an extension pole assembly at the locking collet 161. Also in this illustrated embodiment an optional rigid handle 162 is attached to the extremity support apparatus 150; wherein the handle 162 functions to aid in the rapid interchange of the apparatus 150 between storage and extremity support positions. Such a rigid handle can be attached to embodiments of the present invention at any convenient site on a movable linkage. In the embodiment herein illustrated by FIGS. 17A and 17B the rigid handle 162 is fixedly attached to the element of the four-bar linkage 164 to which the proximal end 165 of the outer tube 152 of the extension pole assembly is rotatable attached. In FIG. 18 is presented a top orthogonal view of the extremity support apparatus 150 in a closed storage position that clearly illustrates the spatial relationship between the slotted plate 153, the slotted plate slot 154, the locking mechanism slot 158 in the locking mechanism 157 and the slotted plate pin 159.

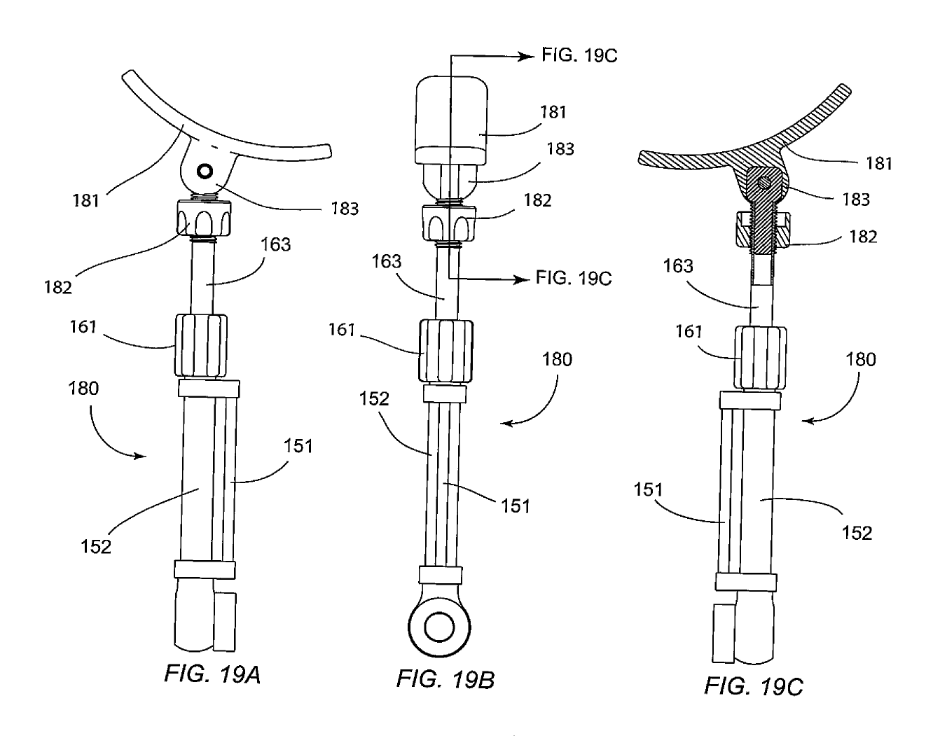

FIGS. 19A and 19B present orthogonal side and frontal views respectively of the extension pole assembly 180 of extremity support apparatus 150 with an attached extremity support member 181 while FIG. 19C depicts a partial sectional orthogonal side view of extension pole assembly 180 of extremity support apparatus 150 attached to the extremity support member 181. These figures clearly show the relationship between the extension pole rod 151 and the outer tube 152. This depicted embodiment utilizes a locking collar 172 threadedly attached to the distal end of the pole assembly inner tube 163 such that tightening the locking collar 172 against the extremity support member base 173 locks the rotatably coupled, extremity support member 181 in a desired position.

Preferred construction materials for components of embodiments extremity support apparatuses of the present invention include, but are not limited to, metal such as aluminum or stainless steel, and most preferably stainless steel. Use of such metals decreases the likelihood of rusting and/or pitting of components and increases the ease of cleaning. Also, use of such materials imparts a substantial durability and sturdiness to the apparatus. Other materials of construction useful for certain elements of embodiments of the present invention include plastics, plastic composites, carbon-reinforced composites and the like.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

We claim:

1. An apparatus attachable to an emergency cot comprising:
one or more cot attachment members attachable to a rail component of the cot;
a movable linkage attached to the cot attachment member;
an extension pole assembly comprising an outer tube with a proximal end and a distal end, wherein the outer tube proximal end is pivotably attached to the movable linkage, and an inner tube with a proximal end and a distal end wherein the inner tube is telescopically coupled within the outer tube; and
an extremity support member rotatably coupled to the distal end of the inner tube;
wherein certain combinations of relative movements of the movable linkage, the extension pole assembly and the extremity support member allow the apparatus to be disposed and secured in positions that support an extremity of a patient lying on the emergency cot and wherein other combinations of relative movements of the movable linkage, the extension pole assembly and the extremity support member allow the apparatus to be disposed in a storage position

2. The apparatus of claim 1 wherein the movable linkage is a four-bar linkage, a three-bar linkage, a hinged coupling or a ball-joint linkage.

3. The apparatus of claim 2 wherein the movable linkage is a four-bar linkage.

4. The apparatus of claim 2 wherein a rail of the cot to which the apparatus is attached defines one bar of the four-bar linkage.

5. The apparatus of claim 3 further comprising a locking mechanism comprising a locking rod and perforated flat plate mechanism.

6. The extremity support apparatus of claim 1 wherein at least one of the extension pole assembly and the support member is provided with a locking means.

7. The apparatus of claim 2 wherein the locking means is selected from the group consisting of a friction clamp having a lead screw, a quick release clamp having a non-circular cam, a friction collar and a collet.

8. The apparatus of claim 7 wherein the locking means is a friction collar or collet.

9. The apparatus of claim 1 further comprising a diagonal brace member with a body having a proximal end, a distal end and a slot extending through the body along its longitudinal axis from a point near the distal end and extending to a point at least past the center point of the longitudinal axis, wherein the proximal end of the diagonal brace is pivotally attached to the movable linkage and wherein the extension pole assembly comprises a locking pin means slidably coupled through the slot of the diagonal support such that the diagonal brace member functions to impart rigidity and strength the apparatus as the extension pole assembly is pivotally rotated relative to the movable linkage.

10. The apparatus of claim 1 further comprising a stabilization mechanism comprising an outer tube rod disposed along and parallel to the longitudinal axis of the outer tube of the extension pole assembly wherein the outer tube rod is attached to the outer tube near the proximal end and distal end of the outer tube such that a space is maintained between the outer tube rod and the outer tube; and a plate comprising a slot having an open end and a closed end; wherein the plate is attached to said one or more cot attachment members such that the slot is parallel to the rail component to which the one or more cot attachment members are attachable such that the slot engages the outer tube rod when the apparatus is in an extended position for use in supporting an extremity of a patient.

11. The apparatus of claim 10 further comprising a locking mechanism comprising a slotted lever rotatably attached to the slotted plate and a slotted plate pin fixedly attached to the slotted plate at or near the open end of the slotted plate slot wherein the slotted lever comprises a lever slot sized and positioned to engage the slotted plate pin and functioning to prevent the outer tube rod from disengaging when disposed in the slotted plate slot.

12. The apparatus of claim 1 wherein the one or more cot attachment members comprise one or more C-clamps.

13. The apparatus of claim 1 wherein the extremity support member is contoured to conform to the shape of a patient's extremity.

14. The apparatus of claim 1 wherein the extremity support member further comprises a replaceable pad.

15. The apparatus of claim 1 wherein the extremity support member has contours arranged to be easily gripped by the hand of a patient.

16. The apparatus of claim 1 wherein the rail component of the cot is a frame rail or a side rail.

17. The apparatus of claim 1 further comprising a rigid handle attached the movable linkage.

18. The apparatus of claim 1 further comprising a retaining-clip disposed and configured to springedly engage and retain extension pole assembly when the apparatus is disposed in a storage position.

19. An apparatus attachable to a phlebotomy chair comprising:
one or more chair attachment members attachable to an arm rail of the chair;
a movable linkage attached to the one or more chair attachment members;
an extension pole assembly comprising an outer tube with a proximal end and a distal end, wherein the outer tube proximal end is pivotably attached to the movable linkage, and an inner tube with a proximal end and a distal end wherein the inner tube is telescopically coupled within the outer tube; and
an extremity support member rotatably coupled to the distal end of the inner tube of the extension pole assembly; wherein
certain combinations of relative movements of the movable linkage, the extension pole assembly and the extremity support member allow the apparatus to be disposed and secured in positions that support an arm of a patient seated in the chair.

20. The apparatus of claim 19 wherein the movable linkage is a four-bar linkage, a three-bar linkage, a hinged coupling or a ball-joint linkage.

21. The extremity support apparatus of claim 19 wherein at least one of the extension pole assembly and the support member is provided with a locking means selected from the group consisting of a friction clamp having a lead screw, a quick release clamp having a non-circular cam, a friction collar and a collet.

22. The apparatus of claim 19 further comprising a diagonal brace member with a body having a proximal end, a distal end and a slot extending through the body along its longitudinal axis from a point near the distal end and extending to a point at least past the center point of the longitudinal axis, wherein the proximal end of the diagonal brace is pivotally attached to the movable linkage and wherein the extension pole assembly comprises a locking pin slidably coupled through the slot of the diagonal support such that the diagonal brace member functions to impart rigidity and strength the apparatus as the extension pole assembly is pivotally rotated relative to the movable linkage.

23. The apparatus of claim 19 further comprising a stabilization mechanism comprising an outer tube rod disposed along and parallel to the longitudinal axis of the outer tube of the extension pole assembly wherein the outer tube rod is attached to the outer tube near the proximal end and distal end of the outer tube such that a space is maintained between the outer tube rod and the outer tube; and a plate comprising a slot having an open end and a closed end; wherein the plate is attached to said one or more chair attachment members such that the slot is parallel to the chair arm rail to which the one or more cot attachment members are attachable such that the slot engages the outer tube rod when the apparatus is in an extended position for use in supporting an arm of a patient.

24. The apparatus of claim 19 wherein the chair one or more attachment members comprises one or more C-clamps.

25. A method of affording extremity support for a patient disposed in an emergency cot comprising the steps of:
i. providing the apparatus of claim 1;
ii. attaching the apparatus to an emergency cot;
iii. adjusting and securing the apparatus in a position appropriate for supporting a patient's extremity; and
iii. disposing the patient's extremity on the support member.
